(19) United States
(12) Patent Application Publication
(10) Pub. No.: US 2009/0274024 A1
(43) Pub. Date: Nov. 5, 2009

(54) OPTICAL-IRRADIATION-POWER CALIBRATION METHOD AND INFORMATION RECORDING/REPRODUCING UNIT

(76) Inventors: Masaki Nakano, Tokyo (JP); Masatsugu Ogawa, Tokyo (JP)

Correspondence Address: NEC CORPORATION OF AMERICA, 6535 N. STATE HWY 161, IRVING, TX, 75039, US

(21) Appl. No.: 12/441,300

(22) PCT Filed: Sep. 14, 2007
(86) PCT No.: PCT/JP2007/067948

§ 371 Date: Mar. 13, 2009

(30) Foreign Application Priority Data
Sep. 15, 2006 (JP) 2006-250870

(51) Int. Cl. G11B 7/12

(52) U.S. Cl. 369/47.5; G9B/7

(57) ABSTRACT

The optical information recording/reproducing unit distinguishes an unrecorded area of a set optical disc (step A100). Thereafter, recording is performed in the unrecorded area under a plurality of recording conditions wherein the recording power is changed with a bias power being constant, to select a recording power providing an optimum reproduced-signal quality (step B100). Subsequently, recording is performed using the selected recording power under a plurality of recording conditions wherein the recording power is fixed onto the selected recording power and the bias power is changed, to select a bias power providing an optimum reproduced-signal quality (step C100). The selected recording power and the selected bias power are set as the recording-use optical irradiation power and bias power, respectively (step D100).

### TECHNICAL FIELD

The present invention relates to an optical-irradiation-power calibration method and an information recording/reproducing unit and, more particularly, to a method for calibrating an optical irradiation power used upon irradiating a laser beam onto a write-once optical information recording medium to record a pattern train including marks and spaces, as well as an information recording/reproducing unit using such an optical-irradiation-power calibration method.

### BACKGROUND ART

Optical discs for writing/reading data thereon by using a laser beam are widely used. The optical disc has a higher storage density and is capable of recording a large amount of data. Due to operation in a noncontact state, the optical disc has been experiencing a development toward a higher-speed access and a larger-capacity memory device. The optical discs are classified into a read-only type that allows read only, a write-once type that allows the user side to record data only once, and a rewritable type that allows the user side to repeatedly record data. The read-only type is generally used as music CDs and laser discs on the market, and a variety of types are used as external memories for computers or storage devices for documents and images. For the read-only type, a reproduced signal is detected using the change of reflected light quantity from concave-convex pits formed on the optical disc. For the write-once type, a reproduced signal is detected using change of the amount of reflected light from small-size pits formed on the optical disc.

Examples of the write-once optical disc distributed on the market include CD-R, DVD-R, and DVD+R, most of which include a recording member containing organic pigment as a base. As the light source used for performing recording/reproducing on the optical disc, a semiconductor laser having a wavelength between around 780 nm and around 650 nm is used. The optical disc including organic pigment as the base includes an organic-pigment member that has an absorption maximum on a wavelength side shorter than the wavelength of the recording/reproducing-use laser beam, and thus has a so-called high-to-low characteristic wherein the optical reflectance at the recorded mark section formed by laser beam irradiation is lower than the optical reflectance prior to the laser beam irradiation. Formation of the mark section uses a transform (shape distortion) of a resin substrate that is caused as a result of a negative pressure due to decomposition of the organic pigment generated by optical irradiation of the resin substrate to heat the same up to a temperature hither than the transition temperature of the resin substrate.

As the optical discs for achieving a higher recording density therein, there are disc standards such as HD DVD and BD (Blu-Ray). For these next-generation optical discs, a laser beam having a wavelength of around 400 nm to around 410 nm (short-wavelength laser) is used during the recording and reproduction. The write-once discs, which are now under development for use together with the short-wavelength laser, include recording films that are roughly categorized into one using an inorganic material member and another using an organic-pigment member. Among them, the write-once disc using the pigment member is described in Patent Publication-1. The pigment member described in Patent Publication-1 has a maximum wavelength-absorption range which is shifted from the recording wavelength (405 nm) toward the longer wavelength side, and the absorption is not distinguished in the recording wavelength range, and has a significant amount of absorption within the recording wavelength range. The optical disc including an organic-pigment member has a low-to-high characteristic wherein the reflectance of the recorded mark section formed by irradiation of the laser beam is higher than the reflectance prior to the laser beam irradiation.

The rewritable optical discs include CD-RW, DVD-RW, DVD-+RW, DVD-RAM, etc., which are phase-change discs. In addition to them, there is also a magneto-optical disc referred to as MO. As the phase-change disc, HD DVD-RW having a higher capacity is already standardized. These optical discs, referred to as RW or RAM, are configured as the media that allow a direct overwriting (hereinafter simply referred to also as overwriting) i.e., recording while erasing. These optical discs have the advantage of allowing the direct for overwriting, whereby rewrite of the recorded data does not necessitate a two-time operation, i.e., recording of data in the next rotation after erasure of data, and allows a single operation for overwriting. In the direct overwriting medium, upon recording of data, switching of irradiation is performed between the recording power that is related to recording and the erasing power that is related to erasing, depending on the mark and space for recording.

A recording waveform, which configures the recording-use waveform shape, will be described hereinafter. FIG. 28 shows an example of the recording-use optical irradiation waveform. In FIG. 28, Pw, Pw1, Pw2 and Pw3 represent recording powers, Pb represents a bias power, and Pe represents an erasing power. Graph (a) shows a mark section that is to be formed, graph (b) shows a recording-use optical irradiation waveform during an overwriting, and graph (c) shows an optical irradiation waveform irradiated during a non-overwrite recording. Graphs (d) to (f) show a plurality of variations of the rectangular waveform. The waveform shape for forming the mark may be divided into a plurality of pulses ((b), (c)), or may have a basically rectangular shape ((d)-(f)). Although there are several combinations of shapes for a non-mark section (space section), the power for irradiating the space section on the over-writing medium is intended to delete an existing mark in the function thereof. On the other hand, the space on the write-once medium, for which erasure is unnecessary (or impossible), only requires a light intensity that is sufficient for allowing the optical beam to track the disc, whereby the role of the power is different from that for the overwriting medium.

Patent Publication-2 describes that the irradiation power for the space section during the recording is allowed to have a bias power (second intensity) in order for compensating a deficiency in calorie supply of the recording power during a high-speed rotation of the disc. It is also described that the intensity (power) thereof is preferably 5 to 15% of the peak power (first intensity). Patent Publications-3 to -6 describe that the recording waveform used on a next-generation optical medium having a higher density includes a constant recording power and two different bias powers, i.e., bias powers-1 and -2.

The conventional technique for power calibration will be described hereinafter. As to the recording power, the optical disc drive uses a power calibration area (PCA), in a write-once DVD-R for example, formed in a part of optical disc to perform an optimum power control (OPC) at a suitable timing. In addition, the HD DVD-R or -RW includes a drive test zone that may be arbitrarily used by the optical disc drive, whereby the optical disc drive perfonns calibration of a variety of parameters including the recording power by using this area.

Patent Publication-7 and Patent Publication-8 describe a technique for calibrating the erasing power on the rewritable optical disc. Patent Publication-7 includes recording a 11T signal by using a power equal to or above the recording power determined by a gamma technique, irradiating a laser beam having a plurality of erasing power levels while changing the DC erasing power (direct-current light), and measuring the residual signal amplitude of the signal to determine an optimum erasing power. Patent Publication-8 includes continuously irradiating a laser beam having a plurality of erasing power levels while stepwise changing the DC erasing power (direct-current light) by a specific amount to thereby erase the old data (existing data) in a trial way, reproducing the old data section subjected to the trial erasure, and determining the erasing power irradiated onto the section that allows the reproduced signal to have a minimum noise level (amplitude), as the optimum erasing power. Patent Publication-8 also describes a technique for determining the erasing power for a recording power, which is obtained by the OPC technique, based on a ratio, ε (=erasing power/recording power), obtained by an experiment.

In the power calibration, the jitter and error rate of a recording/reproduced signal is used as the performance index thereof to determine the recording power etc. For the power calibration, in addition thereto, there are other techniques, such as a beta technique that inspects asymmetry from the reproduced amplitude of a long mark and the reproduced amplitude of a short mark to obtain a β-value for use as the performance index, and a gamma technique that judges the state based on the degree of the saturation of amplitude of the recorded mark. The beta technique obtains in advance a correlation between the β value and the error amount, for example, for the disc with respect to the drive, and uses the β-value as the performance index. Although a β-value of around zero is considered preferable, the β-value of zero does not necessarily provide the optimum performance, and a β-value deviated from zero, for example, +5% or −7%, may be preferable in some cases.

For the write-once disc, the β-value largely changes depending on the power, is handled with ease as the performance index, and thus is frequently used. The absolute value of β-value has a different meaning (performance) depending on the correlation with respect to the error amount.

There is a PRSNR known as a performance index used for an optical disc having a higher density. The PRSNR is a signal-quality evaluation index that replaces the jitter, and now used in a HD DVD family. The PRSNR is an SNR (signal noise ratio) in PRML (partial-response maximum likelihood), and it is considered that a higher value thereof means a higher signal quality. The detail of PRSNR including conversion thereof into an error rate is described in a Non-Patent Literature-1. It is known that the target value for the performance in the PRSNR is required to be 15 or above. As the performance index, the jitter obtained by a limit equalizer technique, an SAM (sequenced amplitude margin) and the index using the SAM, in addition to the above, may be used in some cases depending on the target storage density, circuit configuration and drive configuration. Non-Patent Literature-2 describes the technique related to the SAM.

Patent Publication-1: JP-2002-187360A

Patent Publication-2: JP-2000-187842A

Patent Publication-3: JP-2005-288972A

Patent Publication-4: JP-2005-293772A

Patent Publication-5: JP-2005-293773A

Patent Publication-6: JP-2005-297407A

Patent Publication-7: JP-2003-228847A

Patent Publication-8: JP-2004-273074A

Non-Patent Literature-1: Japanese Journal of Applied Physics Vol.43, No.7B, 2004, pp. 4859-4862,“Signal-to-Noise Ratio in a PRML Detection”, S.OHKUBO et al.

Non-Patent Literature-2; “Signal Reproducing Technique in a High-Density Optical Disc Drive ”, p.25-30 Okumura et al., Sharp Technical Report, No. 90, December, 2004

Recording and reproduction was performed on a conventional write-once disc medium by using a laser beam having a wavelength range longer than around 650 nm, and revealed that it is unnecessary to use a power corresponding to the space in the write-once optical disc medium including an organic pigment in the recording film. This results from the fact that the write-once disc medium does not inherently require the overwriting. It is to be noted that the fact that the overwriting is impossible on the write-once disc medium also provides the advantage that the write-once disc is free from falsification of data. On the other hand, a medium for which a recording-use optical power including a recording power and a bias power corresponding to the mark and space, respectively, is needed has been developed, such as a write-once disc which includes a recording film configured by an organic-pigment member, for which recording/reproduction is performed using a short-wavelength laser developed recently, and for which the mark is formed by a photochemical reaction or photo-thermal-chemical reaction.

The Patent Publications and Non-Patent Literatures as described above do not describe a power calibration technique for the write-once optical disc medium that requires the recording power and bias power corresponding to tie mark and space, respectively, especially as to the calibration procedure thereof. Such an optical disc medium generally involves the problem that calibration of only the recording power during the power calibration cannot necessarily derive the maximum medium performance. In addition, the fact that the maximum medium performance cannot be derived causes a reduction in the margin, or leads to a reduction in the product yield, thereby providing serious problems. Further, the optical disc medium and optical disc drive for which recording and reproduction is performed using a short wavelength laser developed in these days require a higher degree of accuracy in the parameters, and in particular, the recording parameters used during the data recording must be calibrated more accurately than ever to an optimum value. Thus, there occurs a situation wherein the number of targets for calibration or parameters has increased to thereby require a larger time length in the calibration. It may be considered that all the combinations of recording power and bias power are used for the recording, to thereby calibrate the parameters; however, this increases the calibration time length and consumes a larger calibration area, whereby a suitable solution is not necessarily provided.

The bias power described in Patent Publication-2 is a supplementary power that supplements insufficient heat of the peak power generated due to a higher-speed rotation. Then, use of the procedure described in Patent Publication-2 may be such that calibration of the peak (recording or first intensity) power calibrates the recording power by using the β-value and the bias (second intensity) power equal to around the reproducing power or 5 to 15% of the peak power, and the OPC is again performed using the bias power corresponding to the recording power obtained in advance. However, since the β-value is not an index representing the performance itself, there is a problem in that calibration of the recording-use power by using the β-value as the index cannot necessarily provide an optimum parameter at a higher speed and with a higher degree of accuracy. In particular, in the case of a disc wherein the β-value itself used as the target power selection is unknown, that is, if the β-value is used for a disc wherein the correlation between the β-value and the error performance is unknown, an increased error incurred thereby negates meaning of the β-value itself as the measure, to thereby prevent an accurate calibration, or causes a situation of incapability of calibration. In determination of the power corresponding to the space section, the problem cannot be solved by using a technique of determining the power corresponding to the space section by erasing the mark already recorded, because the disk is the write-once medium.

It is described in the above description, as to the measure of evaluation for determining the power, that use of the β technique cannot necessarily determine the recording-use power with a higher degree of accuracy. There is also a technique wherein determination of the recording power uses the beta technique, gamma technique, or a technique of using the number of errors, and determination of the erasing power uses the residual signal amplitude of a recorded signal, in consideration that the recording/erasing power includes a plurality of recording powers, wherein the erasing power is another recording power (bias power). However, in this case, a complicated processing is needed, to thereby incur the problem of increase in the scale of detection hardware or the number of control programs (firmware programs) that operate the drive.

As described heretofore, there is a demand for development of the technique for calibrating the recording-use optical irradiation power that achieves a higher effectiveness with a higher degree of accuracy and certainty.

### SUMMARY OF THE INVENTION

It is an object of the present invention to provide a recording-use optical-irradiation-power calibration method that is capable of calibrating the recording-use optical irradiation power with a higher degree of certainty, while reducing the time length of calibrating the recording-use optical irradiation power and reducing the calibration area used therefor. It is another object of the present invention to provide an optical information recording/reproducing unit that performs calibration of the optical irradiation power using such a method.

The present invention provides, in a first aspect, a method for calibrating an optical irradiation power in an optical information recording/reproducing unit that performs recording on a write-once recording medium, wherein which a mark is formed by optical beam irradiation, including the steps of recording a specific pattern train in a specific area on the recording medium while stepwise-changing a recording power with a bias power being fixed; reproducing the pattern train recorded in the recording step to measure a reproduced-signal quality; selecting, based on the measured reproduced-signal quality, a single recording power from among recording powers that are stepwise changed therebetween; selecting a bias power by using the selected recording power; and forming a mark by irradiating the selected recording power and the selected bias power.

The present invention provides, in a second aspect, an information recording/reproducing unit that records/reproduces data on a write-once recording medium, wherein a mark is formed by optical beam irradiation, including: a parameter calibration unit (21) that determines a recording power and a bias power of a laser beam that irradiates the recording medium upon performing recording on the recording medium (50), wherein the parameter calibration unit (21): includes a reproduced-signal quality measurement section that measures a reproduced-signal quality; selects a single recording power from among recording powers that are stepwise changed therebetween based on a reproduced-signal quality of a specific pattern train, which is recorded in a specific recording area while stepwise-changing recording power with the bias power being fixed constant, the reproduced-signal quality being measured by the parameter calibration unit; selects the bias power based on the selected recording power; and determines the selected recording power and the selected bias power as an optical irradiation power and a bias power, respectively, upon recording a mark.

The above and other objects, features and advantages of the present invention will be more apparent from the following description, referring to the accompanying drawings.

### BRIEF DESCRIPTION OF THE DRAWINGS

FIG. 1 is a graph showing the relationship between the bias power and the 2ndH/C.

FIG. 2 is a waveform diagram showing the reproduced recorded-waveform of an 8T pattern.

FIG. 3 is a waveform diagram showing the reproduced recorded-waveform of an 8T pattern.

FIG. 4 is a waveform diagram showing the reproduced recorded-waveform of a 13T pattern.

FIG. 5 is a waveform diagram showing the reproduced recorded-waveform of a 13T pattern.

FIG. 6 is a graph showing the relationship between the recording power Pw and the PRSNR.

FIG. 7 is a graph showing the relationship between the bias power, Pb, and the PRSNR.

FIG. 8 is a graph showing the relationship between the bias power and the PRSNR.

FIG. 9 is a graph showing the relationship between the PRSNR and the recording power Pw and bias power Pb.

FIGS. 10A and 10B are mode diagrams each showing the temperature distribution in the recording film relative to the time.

FIG. 11 is a block diagram showing the schematic configuration of an optical information recording/reproducing unit according to an exemplary embodiment of the present invention.

FIG. 12 is a flowchart showing the procedure of calibrating the recording-use optical irradiation power.

FIG. 13 is a flowchart showing the procedure of determining the recording power.

FIG. 14 is a flowchart showing the procedure of determining the bias power.

FIG. 15 is a block diagram showing the circuit section used for detecting the area without a mark.

FIG. 16 is a graph showing the results of measurement of the reproduced-signal quality upon determining the recording power.

FIG. 17 is a graph showing the results of measurement of the reproduced-signal quality upon determining the bias power.

FIG. 18 is a conversion table showing the correspondence relationship between the recording power and the bias power.

FIG. 19 is a graph showing the results of measurement of the reproduced-signal quality upon determining the recording power.

FIG. 20 is a flowchart showing the procedure of calibrating the recording-use optical irradiation power.

FIG. 21 is a table showing a concrete example of the information for each disc manufacturer stored in the unit.

FIG. 22 is a graph showing the results of measurement of the reproduced-signal quality upon determining the recording power.

FIG. 23 is a flowchart showing the procedure of calibrating the recording-use optical irradiation power.

FIG. 24 is a graph showing the results of measurement of the reproduced-signal quality.

FIG. 25 is a table showing a concrete example of the information for each disc manufacturer stored in the unit.

FIG. 26 is a graph showing the relationship between the recording power and the PRSNR.

FIG. 27 is a graph showing the relationship between the bias power and the PRSNR.

FIG. 28 is a waveform diagram showing a variety of recording-use optical irradiation waveforms.

FIG. 29 includes a graph (a) showing a ST mark to be recorded and a graph (b) showing a pulse train waveform for the 5T mark.

### EXEMPLARY EMBODIMENTS OF THE INVENTION

Hereinafter, the investigation performed before accomplishment of the present invention will be described, prior to description of exemplified embodiment of the present invention. In the following investigation, the optical head used therein was one having a

LD wavelength of 405 nm, and a NA (numerical aperture) of 0.65. The optical disc used therein was one including an in-groove-format-use guide groove provided on a polycarbonate substrate having a diameter of 120 mm and a thickness of 0.6 mm. The density of data recorded is such that the bit pitch is selected at 0.153 μm and the track pitch is selected at 0.4 μm. The recording film of the optical disc used therein was one including a short-wavelength-use organic pigment. This is the type allowing the recording only once.

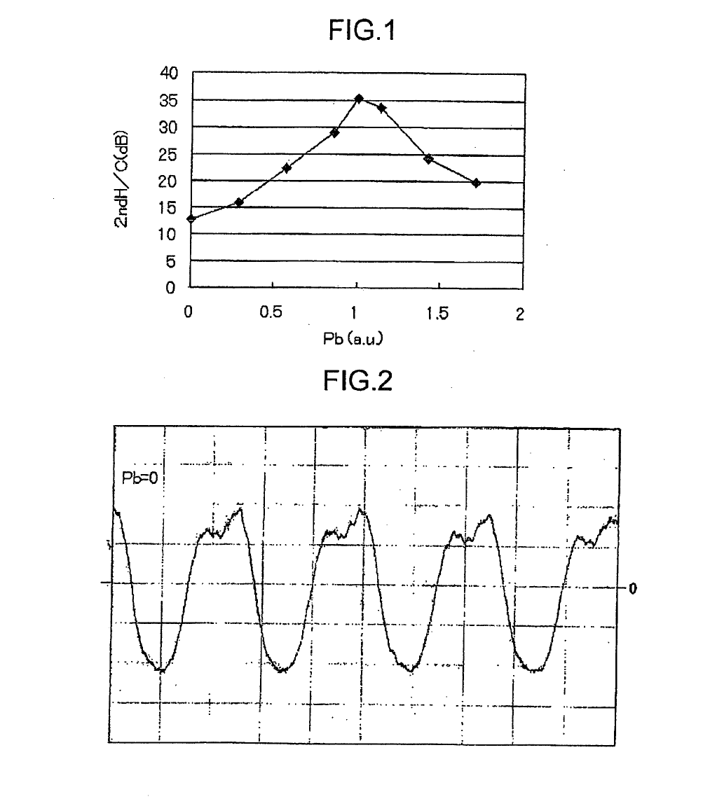

FIG. 1 shows 2ndH/C in the reproduced signal obtained upon reproducing an 8T pattern recorded by using a single 8T pattern at a constant recording power of 11 mW while changing the bias power. The 2ndH/C is a difference between the signal career and the secondary harmonic wave of the signal on the frequency axis, configuring an index wherein a larger value thereof means a lower waveform distortion. In FIG. 1, the abscissa is normalized by a reference bias power, wherein the bias power is represented by a power ratio of the same to the reference bias power. With reference to the same figure, it is understood that the 2ndH/C assumes an optimum value when the bias power Pb assumes a power ratio of 1, at which the waveform distortion is alleviated.

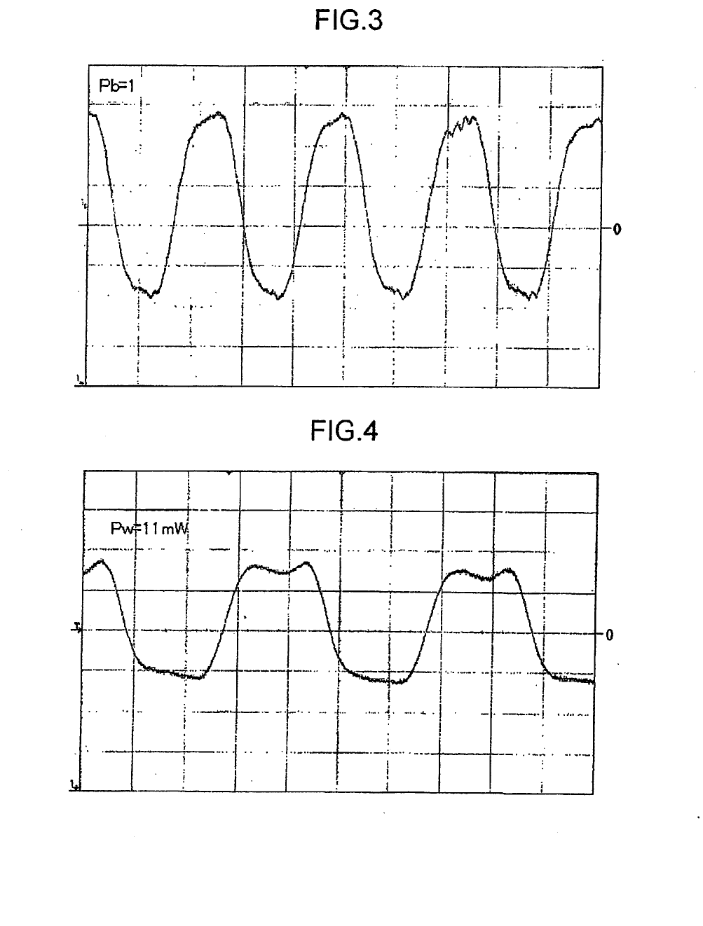

FIGS. 2 and 3 each show a reproduced recorded-waveform of an 8T pattern recorded. FIG. 2 shows the reproduced waveform for the case of bias power Pb equal to “0”, whereas FIG. 3 shows the reproduced waveform for the case of bias power Pb equal to “1”. The upper side of the reproduced signal corresponds to the mark section, whereas the lower side thereof corresponds to the space section. With reference to FIGS. 2 and 3, the upper-side mark section has a depression when Pb=0 (FIG. 2), and it is confirmed that the depression in the tipper-side mark section is alleviated when Pb=1 (FIG. 3), which provides an optimum value for the 2ndH/C.

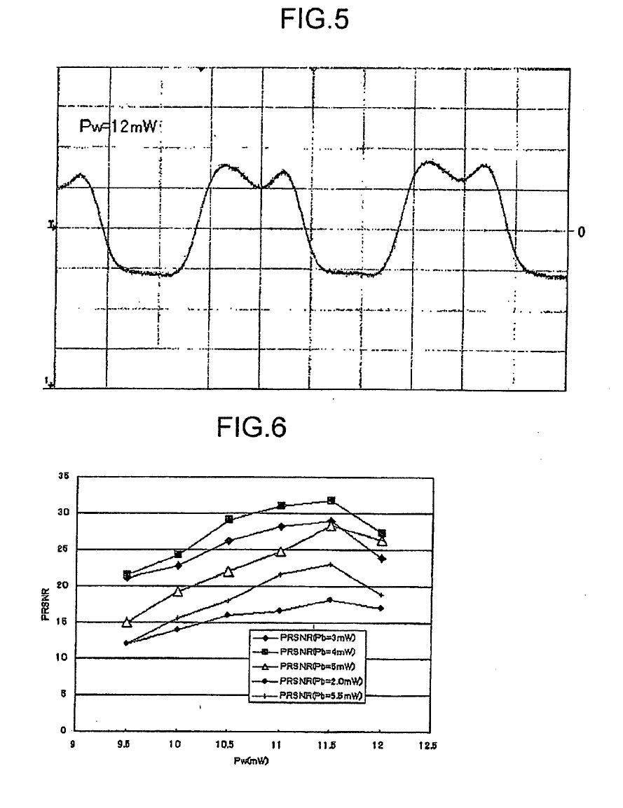

The depression on the upper-side mark section shown in FIG. 2 has a strong dependency on the bias power Pb, and a weak dependency on the recording power Pw. FIGS. 4 and 5 show the reproduced recorded-waveforms of a 13T pattern recorded by the recording power Pw at 11 mW and 12mW, respectively, with the bias power Pb=0. Comparing the case of recording power Pw being at 11 mW (FIG. 4) and the case of recording power being at 12 mW (FIG. 5), it will be understood that an increase of the recording power does not alleviate the depression on the upper-side mark section. In this way, a mere increase of the recording power to thereby increase the heat quantity provided to the recording film cannot alleviate the depression of the upper-side mark section.

FIG. 6 shows the relationship between the recording power Pw and the PRSNR. When recording is performed using five levels of the bias power Pb at 2.0 mW, 3.0 mW, 4.0 mW, 5.0 mW, and 5.5 mW, while changing the recording power Pw corresponding to the mark section, and the PRSNR of the reproduced signal is measured, the graph shown in FIG. 6 is obtained. With reference to the same figure, the recording power Pw that provides an optimum PRSNR is constant irrespective of any value for the bias power Pb, whereby it is understood that the recording power that provides an optimum recorded state can be selected with ease.

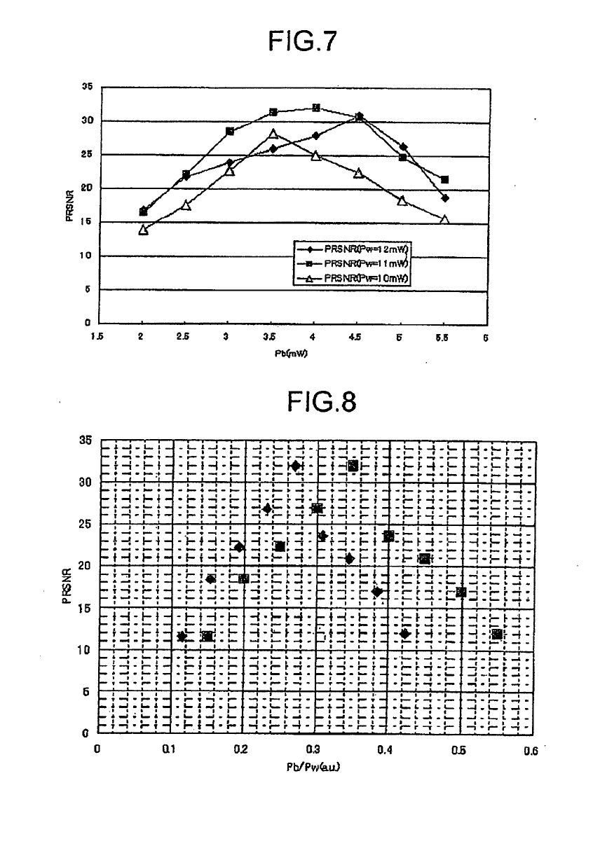

FIG. 7 shows the relationship between the bias power Pb and the PRSNR. On the contrary to the above, when recording is performed using three levels of the recording power Pw at 10 mW, 11 mW, and 12 mW, while changing the bias power corresponding to the space section, and the PRSNR of the reproduced signal is measured, the graph shown in FIG. 7 is obtained. With reference to the same figure, the bias power Pb that provides an optimum PRSNR assumes different values depending on the recording power Pw, whereby it is understood that an optimum performance may not be obtained depending on the combination of the bias power Pb and the recording power Pw.

FIG. 8 shows the relationship between the bias power and the PRSNR when the recording waveform shape is changed. In FIG. 8, the abscissa (bias power) is normalized by the recording power. Recording was performed using two recording waveform shapes (♦ and ▪ in FIG. 8) having different positions, as viewed along the time axis, of the rectangular waveform of the mark-forming-use laser irradiation (edge of each pulse in a multiple-pulse waveform and edge of a single rectangular waveform), while changing the bias power, followed by measuring the PRSNR, thereby providing the results shown in FIG. 8. It is known that the power for forming the mark is determined by the waveform shape and the total heat quantity of the power, and that the waveform shape (waveform shape along the time axis direction) and the power can be exchanged therebetween within a narrow range of the vicinity of the optimum power. Thus, the two recording conditions having different recording waveform shapes provide different recording powers by the difference in the width along the time axis direction of the laser irradiation rectangle, whereby the optimum recording power is changed in the power value by the heat quantity corresponding to the time width. The ♦ and ▪ in this case use parameters corresponding to the opposing ends of the margin of the recording strategy that provide an equivalent performance.

With reference to FIG. 8, it is understood that a bias power in the range of ratio of the bias power to the recording power (Pb/Pw) being between 15% and 50% renders the PRSNR to assume 15 or above. In addition, a bias power in the range between 18% and 45% renders the PRSNR to exceed 20, and a bias power in the range between 20% and 40%, in particular, renders the PRSNR to assume 23 (that is equivalent to an error rate of 10⁻⁶) or above. Thus, it is understood that, for any recording waveform shape, it is possible to maintain the PRSNR at 15 or above, to reveal the remarkable effect thereof. It is to be noted that the PRSNR equal to 15 is the target value that is a minimum value acceptable on the device operation.

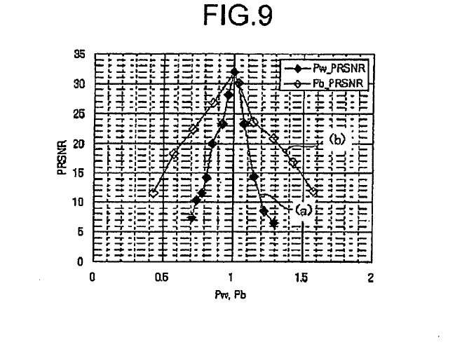

FIG. 9 shows the relationship of the PRSNR with respect to the recording power Pw and bias power Pb on the same graph. Graph (a) shows the PRSNR upon changing the recording power Pw, with the bias power Pb being constant. Graph (b) in the same figure shows the PRSNR upon changing the bias power Pb, with the recording power Pw being constant. The abscissa of the graph represents the recording power Pw and bias power Pb, which are normalized by the central value thereof. Comparing graph (a) and graph (b), it is understood that the margin of the bias power Pb is wider than the margin of the recording power Pw. This shows that it is possible to calibrate the recording power, in other words, to determine the size of the recording mark, even if the bias power is not necessarily determined. to allow the PRSNR to assume an optimum value, that is, the bias power is roughly determined.

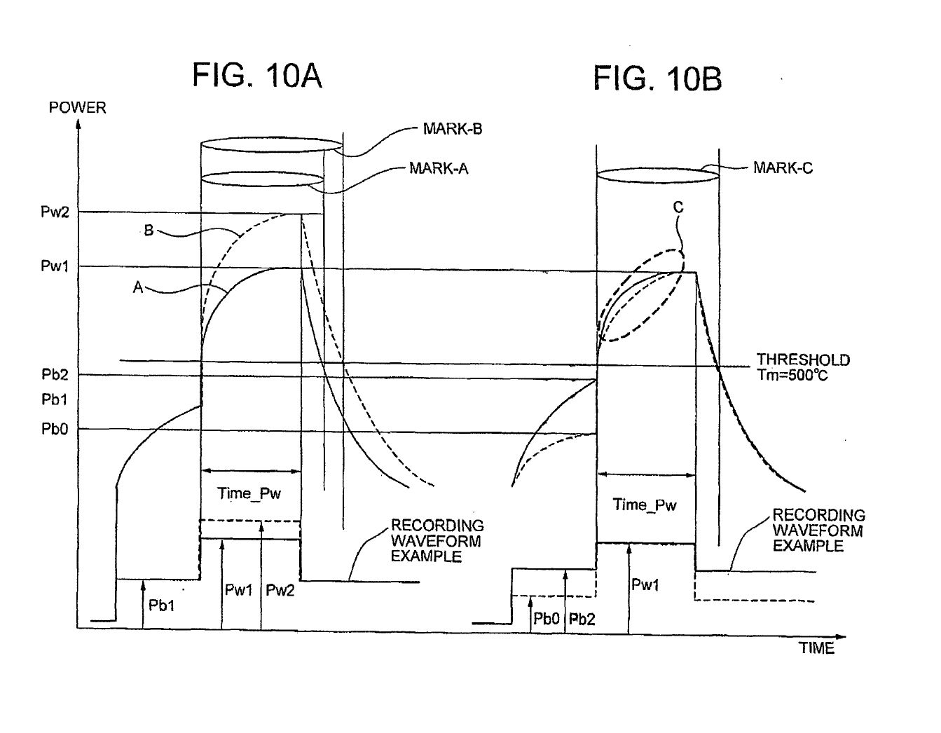

The above situation will be described using the following simulation model. FIGS. 10(a) and 10(b) show the model in which the temperature distribution in the recording film is 1.5 shown with respect to the time. As to the size (length) of a mark upon forming the mark, a part exceeding a mark-forming temperature (for example, Tm=500° C.) contributes to the formation thereof. When the recording pulse is irradiated onto the optical disc, and if the power of the laser beam irradiated onto the recording film is increased from the level of bias power Pb to the level of recording power Pw, the temperature of the recording film rises up to a temperature corresponding to the intensity of the recording power Pw. If the irradiating power is thereafter lowered down to the level of the bias power Pb at the rear edge of the recording pulse, a mark is being formed until the temperature of the recording film is lowered down to the temperature below 500° C.

A case will be considered here wherein the recording is performed using two recording powers Pw1 and Pw2 by changing therebetween the recording power Pw, with the bias power Pb being constant. FIG. 10(a) shows the recording waveform in this case. The relationship between the recording powers is Pw2>Pw1. The temperature change of the recording film during irradiating the recording pulse having the recording power Pw1 changes such as shown by graph A in FIG. 10(a), and the temperature change of the recording film during irradiating the recording power Pw2 changes such as shown by graph B. Marks, i.e., mark A and mark B, formed by the recording powers Pw1 and Pw2, respectively, are additionally shown in FIG. 10(a). The marks are formed if the temperature of the recording film is higher than the threshold Tm=500° C. for forming the mark. As described above, the maximum point of temperature is different between the recording powers Pw1 and Pw2 during irradiation of the recording power. The maximum point of temperature in the recoding film during irradiation of the recording pulse having a recording power Pw2 is higher than the maximum point of temperature therein during irradiation of the recording power Pw1. Due to this temperature difference during irradiation of the recording pulse, there arises a difference in the time length from the rear edge of the recording pulse to the time instant at which the temperature of the recording film falls down to below 500° C., thereby providing a difference in the length of the mark formed on the medium.

Next, a case is considered wherein the bias power is changed between Pb0 and Pb2 with the recording power being fixed at Pw1. FIG. 10(b) shows the recording waveform for this case. In this case, comparing the temperature rise during irradiation of the recording pulse for the case of bias power being at Pb0 against the temperature change during irradiation of recording pulse for the case of bias power being at Pb2 (Pb2>Pb0), there scarcely arises a difference in the maximum temperature of the recording film, although there is some difference in the way of temperature rise in the area denoted by area-C in FIG. 10(b) after the pulse irradiation. The length (size) of mark during formation of the mark is determined by the time length during which the temperature of recording film exceeds the threshold Tm=500° C., and does not depend on the other parameters. Thus, the same mark-C is formed for both the cases of bias power being set at Pb0 and Pb2. More specifically, there is no difference therebetween in the length of mark thus formed. Accordingly, the bias power is not the factor that significantly changes the mark size.

In a system using the PRML in which the amplitude information is important, the dominating factor of the performance is the amplitude level determined by the mark size. The effect of the bias power is a recording-mark shaping effect in which the bias power shapes the mark, and scarcely has an influence on determination of the mark size. Thus, it can be construed that the effect of the bias power is a side effect that suppresses the range of variation in the amplitude level by the mark shaping, thereby stabilizing the mark shape to improve the signal quality.

As described heretofore, it may be concluded in the combination of the recording power and bias power, even if the bias power is roughly selected, that the recording power (peak power) mainly determines the mark size (length), whereas the bias power is not the factor that significantly changes the mark size. From this, the present inventors have come to the findings that the maximum performance can be obtained at a higher speed with a higher degree of certainty by adopting the calibrating procedure of first determining the optimum recording power and thereafter determining the mark-shaping power matched with the recording power, i.e., matched with the mark shape formed by the recording power.

In addition, the above calibration procedure uses the reproduced-signal quality, such as the PRSNR, having a sense of the performance index in the absolute value thereof, thereby detecting the optimum condition with a higher degree of accuracy. A trial calibration was performed wherein the β-value was used as the performance index, and the recording power Pw was selected for the selection target of the β-value, i.e., β-value=0. The recording power Pw providing the β-value=0 assumed different values depending on the bias power, and thus the β-value was deviated depending on the setting of the bias power, whereby calibration of the recording power Pw and bias power Pb in this order could not lead to the optimum condition.

Even the use of PRSNR could not lead to the true optimum condition so long as the order of calibration was reversed, i.e., so long as the order of calibration was such that the bias power Pb was first determined, followed by determining the recording power Pw based on the determined bias power Pb. This is attributable to the fact that the optimum bias power Pb is deviated by the recording power Pw if the power is selected based on the measure of PRSNR. More specifically, finding of the optimum recording power when the bias power Pb is deviated, if employed, does not necessarily provide the PRSNR exhibiting the maximum performance, whereby the optimum recording power cannot be obtained. Thus, even if the optimum condition may be found, a plurality of retrial operations will be needed. The fact that the maximum performance owned by the medium cannot be derived, or that a longer time length is needed for the calibration to obtain the optimum performance is the fatal defect of the drive.

There is also a measure that raises the power at the front edge of the recording waveform without using the bias power. However, it was confirmed that even the use of this measure disturbs the waveform shape of the space section due to diffusion of the heat of the front edge toward a preceding space section (non-mark section), and that the overall performance is difficult to improve and a simple calibration cannot be obtained. Further, although the conventional medium has a strong thermal interference and thus the formation of mark is mainly to change the shape, it is probable that the medium including the short-wavelength-use organic pigment is of a reaction type that uses a photochemical reaction or photo-thermal-chemical reaction. It was confirmed that the validity of the present invention is particularly higher in the medium wherein the optical reflectance of the mark section formed by irradiation of the optical beam is higher than the optical reflectance prior to the laser beam irradiation.

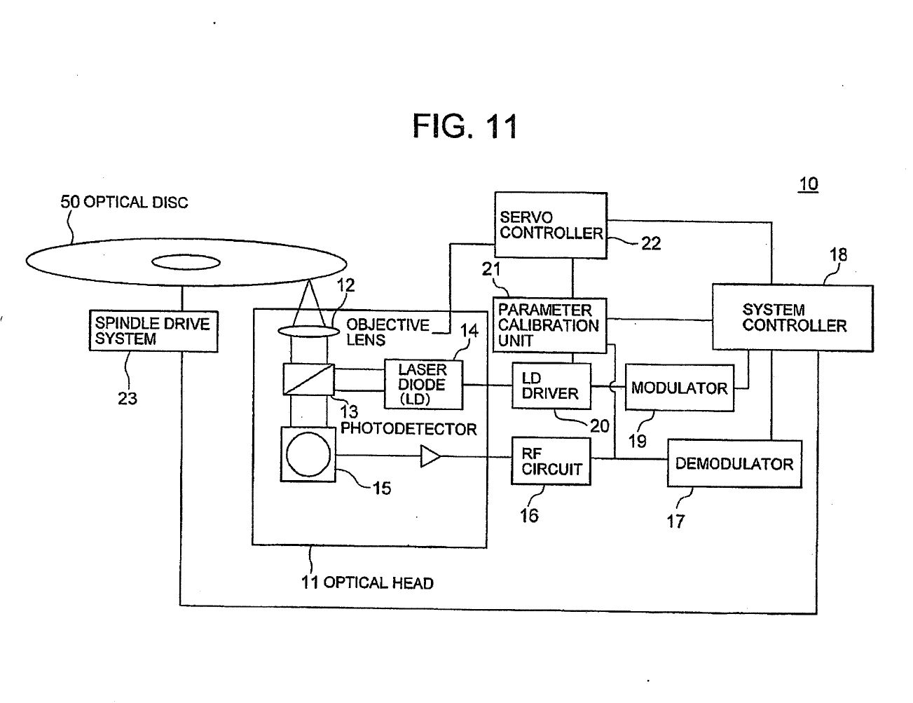

Hereinafter, exemplary embodiment of the present invention will be described with reference to the drawings. FIG. 11 shows outline of the configuration of an optical information recording/reproducing unit according to an embodiment of the present invention. The optical information recording/reproducing unit 10 includes an optical head 11, an RF circuit 16, a demodulator 17, a system controller 18, a modulator 19, a LD driver 20, a parameter calibration unit 21, a servo controller 22, and a spindle drive system 23. The optical head 11 includes an objective lens 12, a beam splitter 13, a laser diode (LD) 14, and a photodetector 15. The optical head 11 emits light onto the optical disc 50, and detects the light reflected from the optical disc.

The spindle drive system 23 drives the optical disc for rotation during performing recording/reproducing on the optical disc 50. The LD 14 emits the light that is incident onto the optical disc 50. The light emitted from the LD 14 is reflected by the beam splitter 13, which reflects the light from the LD 14 and passes therethrough the reflected light from the optical disc 50, and advances toward the objective lens 12. The objective lens 12 focuses the light emitted from the LD 14 onto the information recording surface of the optical disc. The reflected light from the optical disc 50 is incident onto the beam splitter 13 via the objective lens 12, passes through the beam splitter 13, and is detected by the photodector 15. The photodector 15 outputs a signal corresponding to the received, reflected light toward the RF circuit 16.

The RF circuit 16 performs a filtering processing etc. with respect to the input signal The demodulator 17 demodulates the signal input thereto via the RF circuit 16. The modulator 19 modulates the recording signal. The LD driver 20 drives the LD 14. The servo controller 22 controls a servo signal and performs a servo control including a tilt control and an astigmatismus control. The system controller 18 controls the entire device. The parameter calibration unit 21 performs parameter calibration of the power etc. in the recording condition. The parameter calibration unit 21 performs judgment of the reproduced-signal performance (reproduced-signal quality). PRSNR or error rate is used for the reproduced-signal quality. The RF circuit 16 has a function as a reproduced-signal-quality unit, and takes charge of calculation of the PRSNR or error rate. In addition thereto, the optical information recording/reproducing unit 10 includes a temperature detecting unit not illustrated.

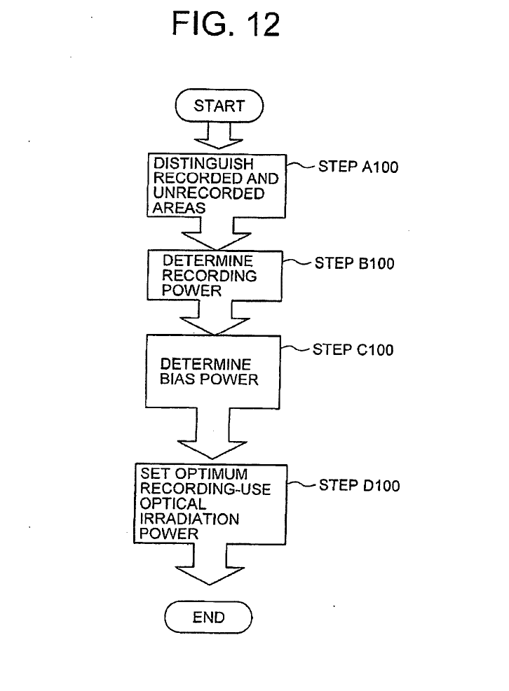

FIG. 12 shows the procedure of calibration of the recording-use optical irradiation power. The optical information recording/reproducing unit 10 distinguishes an unrecorded area of the optical disc 50 (step A100). In step A100, the unrecorded area is distinguished and judged by investigating presence or absence of a recorded mark based on the reproduced signal in the area that is usable for power calibration or a variety of calibrations, for example. In an alternative, by reading from the optical disc 50 information representing the area up to which the mark is recorded, the unrecorded area is distinguished. Thereafter, using the parameter calibration unit 21, recording is performed in the unrecorded area while changing the recording power with the bias power being constant, the recorded data is then reproduced, and the reproduced-signal quality is judged to determine the recording power (step B100).

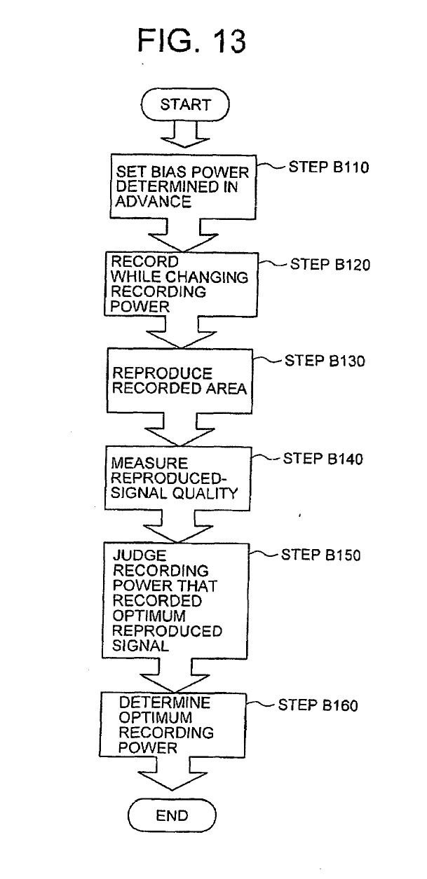

FIG. 13 shows the procedure of determining the recording power in step B100. Upon determining the recording power, the parameter calibration unit 21 first sets the bias power at a specific power determined in advance (step B110). Step B110 sets an average bias power, for example, of the powers acquired by calibration from the media that are usable for an experiment. The bias power set at this stage is 20 to 40% of the recording power (the power mainly engaged in formation of the mark after the start of recording) that is concluded as the most desirable range from the result of intensive investigation by the present inventors. In an alternative, an average bias power may be calculated with respect to the central value of the recording powers used in the next step, wherein the recording is performed using the different recoding powers, by calculation using the ratio of the bias power to the recording power, and may be used. In a further alternative, information as to the power may be read out from the optical disc 50, and may be used.

Subsequently, the parameter calibration unit 21 generates a plurality of recording conditions including stepwise-changed recording powers. The system controller 18 performs recording in the unrecorded area of the optical disc 50 under the plurality of recording conditions including different recording powers generated by the parameter calibration unit 21. In step B120, the recording is performed at the recording powers that are varied within a range of around ±10% from the central value, that is an average recording power of the powers obtained in advance by using calibration in an experiment etc. The recording powers are varied stepwise at a 0.5-mW step, for example. The bias power is fixed at a bias power that is set in step B110. The central value of the recording power may be determined using information of the power read from the optical disc 50. In this case, it happens often that the power, which is prepared by the disc manufacturer, is not the optimum power. However, this information is more advantageous compared to the case of absence of such information, and may be used as the initial central power for the next finding.

If needed information is not obtained in advance, the maximum emitting power of the LD used in the device for recording and the power margin may be estimated so as to obtain the central value of the recording powers. In this case, if the maximum emitting power used for recording in the device is 12 mW, for example, the part of margin therein is estimated at ±20%, revealing that the initial specific recording power is 10 mW. If the specific bias power determined in advance is set at 20 to 40% of the recording power, a power is obtained using 30% which is a median value between 20% and 40% of the recording power, and thus the bias power is selected at this stage at 3.0 mW for setting.

The system controller 18 reproduces the area recorded in step B120 by using the optical head 11, RF circuit 16, demodulator 17, etc. (step B130). The RF circuit 16 measures the reproduced-signal quality corresponding to the area recorded by each recording power (step B140), and feeds the information of reproduced-signal quality to the parameter calibration unit 21. The parameter calibration unit 21 judges the received reproduced-signal quality (step B150), and determines the recording power used for recording under the condition that provided the best reproduced-signal quality as the optimum recording power (step B160).

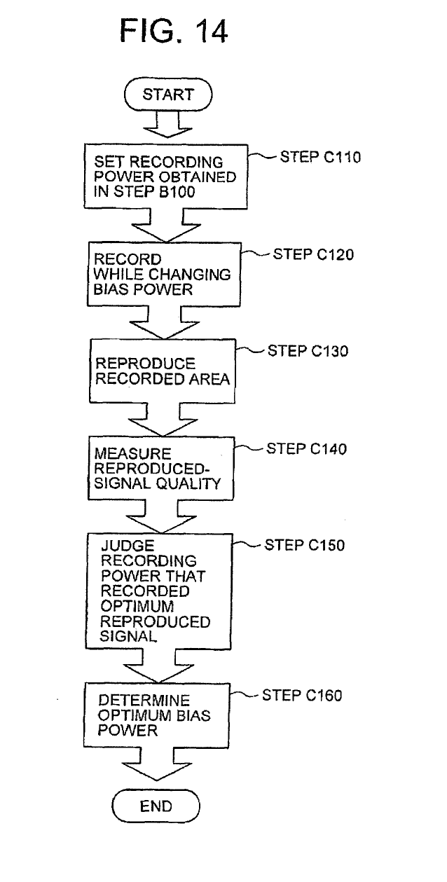

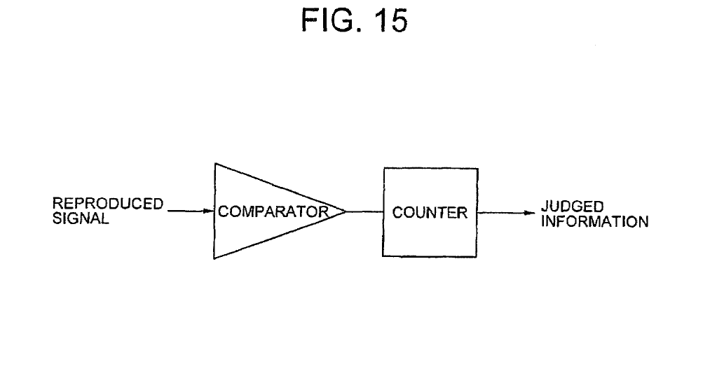

Back to FIG. 12, the optical information recording/reproducing unit 10 fixes the recording power to a recording power that is determined in step B100 (the optimum recording power determined in step B160 in FIG. 13), performs recording while changing the bias power, reproduces the recorded data, and judges the reproduced-signal quality to thereby determine the bias power (step C100). FIG. 14 shows the procedure of determining the bias power. The parameter calibration unit 21 first sets the recording power at the optimum recording power determined in step B 160 (step C110). Subsequently, the parameter calibration unit 21 fixes the recording power and creates recording conditions including stepwise-changed bias powers.

The system controller 18 performs recording,. under each of a variety of recording conditions created by the parameter calibration unit 21, onto the unrecorded area of the optical disc 50 (step C120). In step C120, the recording is performed using the bias power that is varied within a range of ±25% from the central value of the average bias power obtained in advance by calibration in an experiment etc, for example. The bias power is varied stepwise in a 0.5-mW step, for example. The central value of the bias power may be determined using information of the power read from the optical disc 50.

The system controller 18 reproduces the area recorded in step C120 by using the optical head 11, RF circuit 16, demodulator 17, etc. (step C130). The RF circuit 16 measures the reproduced-signal quality corresponding to the area recorded using each bias power (step C140), and feeds the information of reproduced-signal quality to the parameter calibration unit 21. The parameter calibration unit 21 judges the received reproduced-signal quality (step C150), and determines tile bias power used for recording under the condition that provided the best reproduced-signal quality, as the optimum bias power (step C160).

Back to FIG. 12 again, the optical information recording/reproducing unit 10, upon determining the recording power and bias power, sets the combination thereof as the recording-use recording condition (step D100). More specifically, the parameter calibration unit 21 sets the combination of the optimum recording power determined in step B160 (FIG. 13) and the optimum bias power determined in step C160 (FIG. 14) as the recording-use recording condition. At this stage, a difference in the power sensitivity caused by a tilt between the optical disc 50 and the optical head 11, temperature change of the device and difference of the device configuration (there is also a combination that generates a difference in the sensitivity of mark formation or shaping with respect to the power) may be corrected using a correction value that is calibrated in advance.

In the present exemplary embodiment, determination of the recording-use optical irradiation power along the above procedure provides a high-speed and accurate calibration of the optical irradiation power during recording using the optical beam irradiation onto the write-once medium for which the recorded mark is formed by optical beam irradiation. This is because the optimum recording power is determined at a high speed in a simple way without depending on the bias power that relates to shaping of the recorded mark, and the bias power (waveform shaping power) matched with the recorded mark formed by the optimum recording power is determined as the optimum bias power. Therefore, as compared to the case where the calibration is performed by recording and reproducing using all the combinations of powers, the calibration time length upon calibrating the power relating to the recording can be drastically reduced. In addition, this leads to the advantage of suppression of the calibration area to be consumed.

In the present exemplary embodiment, it is not needed to perform a complicated processing such as using the target value corresponding to each type of the powers, whereby a variety of device resources can be reduced to thereby reduce the cost thereof. This is because the SNR (PRSNR) or error rate is used as the unified evaluation index during calibration of both the recording power and bias power. In addition, in consideration of the current situation wherein an explosive increase of the number of disc manufactures has arisen, as a result causes appearance of a larger number of so-called unknown discs, the source of which is unknown, and thus causes the device not to catch up with the discs, it is inevitable to calibrate the parameters relating to the performance. As the performance index therein, use of the PRSNR or error rate having a sense of performance index in the absolute value thereof provides the advantage of providing a capability of handling a variety of media, improving the user's convenience and assuring a higher reliability as compared to the target that necessitates an advance calibration corresponding to the performance to some extent.

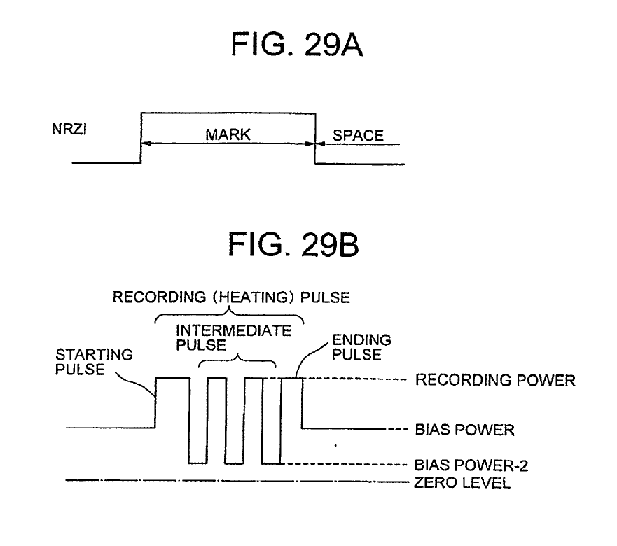

Hereinafter, description will be provided using Examples. In Example-1, an optical head having a LD wavelength of 405 nm and a NA (numerical aperture) of 0.65 was used as the optical head 11 (FIG. 11). The optical disc 50 used herein was one including a polycarbonate substrate, which had a diameter of 120 mm and a thickness of 0.6 mm and on which an in-groove-format-use guide groove was formed. As the density of data recorded, a bit pitch of 0.153 μm and a track pitch of 0.4 μm were employed. The recording film used herein was one including an organic pigment family used for a short wavelength. The disc was of a write-once type that allows writing only once. The modulation/demodulation code used was an ETM (eight-to-twelve modulation) that is based on RLL (1, 7). The recording strategy used was a pulse-train strategy of (k−1) rules including a plurality of pulses. This strategy uses a rule such that if the recording mark length is kT (k is an integer not less than two and T is a channel clock period), the mark is formed using a group of (k−1) recording (heating) pulses. FIG. 29(a) shows a 5T mark to be formed, and FIG. 29(b) shows the pulse train waveform for the 5T mark.

The recording condition was calibrated along the procedure shown in FIG. 12 by using the optical information recording/reproducing unit 10. In step A100, the optical head 11 was moved to a drive test zone of the optical disc 50 in which the parameter calibration is performed as desired, to detect an area without a mark. Detection of the area without a mark used a means that can detect the number of detection times of non-mark within a specific time length from a specific starting position while using a count start signal and a count end signal. The recording was performed using a plurality of recording conditions wherein the recording power is changed within a specific range from the center of the average recording power stored in the device as the information thereof, with the bias power being fixed onto the average bias power stored in the device as the information thereof.

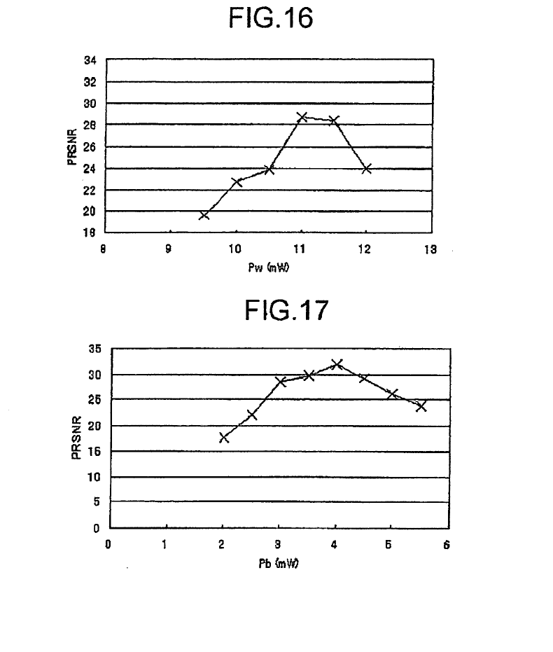

In step B140, the recorded area was reproduced, to measure the reproduced-signal quality for each recording condition. FIG. 16 shows the results of measurement of the reproduced-signal quality. In step B160, a recording power of Pw=11 mW was determined from the measurement results shown in FIG. 16 as the optimum recording power of the recoding condition that provides the maximum PRSNR. Thereafter, in step C120 (FIG. 14), the bias power was changed within a specific range from the center of the average bias power stored in the device to perform recording under a plurality of recording conditions, with the recording power being fixed onto Pw=11 mW determined as the optimum recording power. Reproduction of the recorded area to measure the reproduced-signal quality provided the measurement results shown in FIG. 17. In step C160, a bias power of Pb=4 mW was determined as the optimum bias power of the recording condition that provides the maximum PRSNR from the measurement results shown in FIG. 17.

From the above, a combination of the recording power Pw=11 mW and bias power Pb=4 mW was determined as the recording-use recording condition. Comparing the reproduced-signal quality in FIG. 16 against the reproduced-signal quality in FIG. 17, the maximum value of PRSNR at 29 before the calibration of bias power (FIG. 16) was improved up to about 32 (FIG. 17) after the calibration of the bias power, whereby the effectiveness of the present invention could be assured.

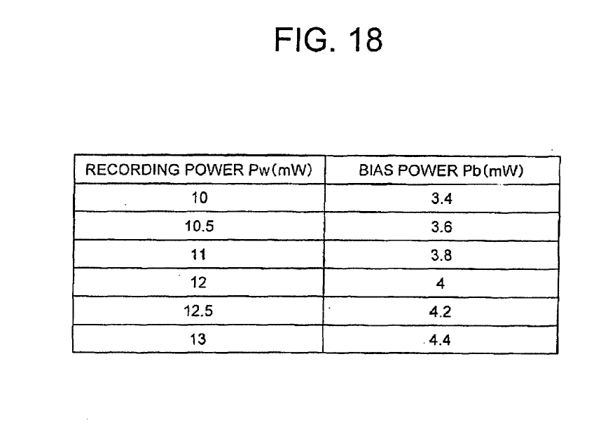

Next, Example-2 will be described. The basic configuration of Example-2 is similar to that of Example-1, and the content of processing thereof for determining the bias power (in step C100 of FIG. 12) is different from that of Example-1. In the determination of bias power, the bias power is determined using the correspondence table (conversion table) between the recording power and the bias power. FIG. 18 shows a concrete example of the conversion table. Using this conversion table, for a recording power of 10 mW, for example, the bias power Pb is determined at 3.4 mW. The conversion table shown in FIG. 18 is obtained in advance, and stored in the device.

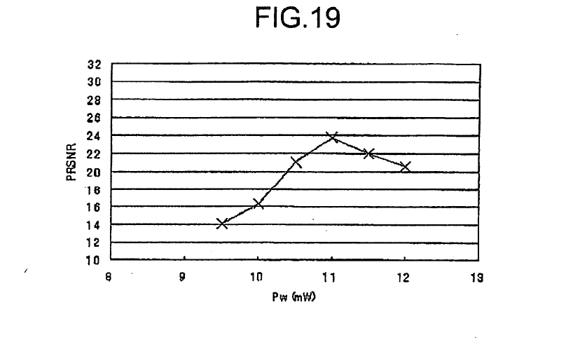

Calibration of the recording condition was performed using the optical information recording/reproducing unit 10 having a configurational similar to that of Example-1. First, the optical head 11 (FIG. 11) was moved to the drive test zone of the optical disc 50, and an area without a mark was detected. Subsequently, recording was performed under a plurality of recording conditions while changing the recording power within a specific range from the center of the average recording power with the bias power being fixed onto the average bias power stored in the device as the information thereof, to measure the reproduced-signal quality. Thereafter, the optimum recording power was determined based on the measured reproduced-signal quality. FIG. 19 shows the measurement results of the reproduced-signal quality. From the measurement results, a recording power of Pw=11 mW that provided the best reproduced-signal quality, i.e., the maximum PRSNR, was determined as the optimum recording power.

After determining the recording power, the bias power was determined. Determination of the bias power used the conversion table shown in FIG. 18. With reference to FIG. 18, the bias power Pb corresponding to a recording power of Pw=11 mW is 3.8 mW, whereby the bias power Pb was determined at 3.8 mW. Recording was performed using a combination of the recording power Pw=11 mW and bias power Pb=3.8 mW to measure the PRSNR, and the resultant PRSNR was 32. From this result, the effectiveness of the present invention could be assured.

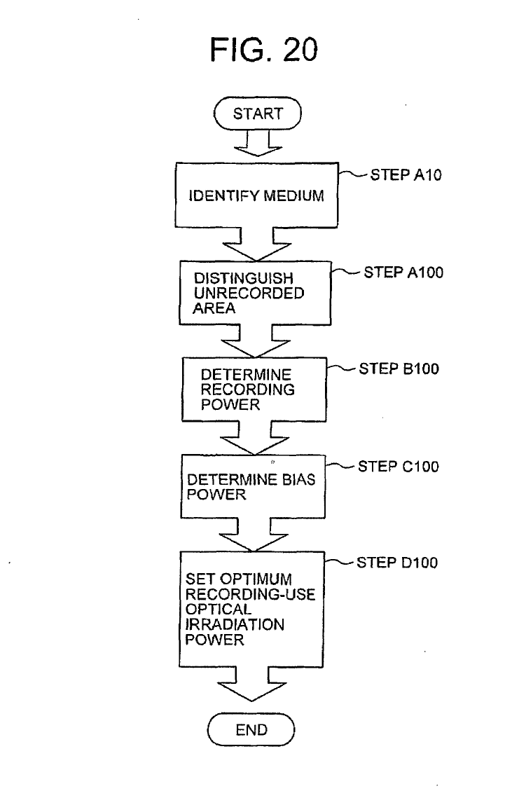

Example-3 will be described. The basic configuration of Example-3 is similar to that of Example-1, and Example-3 is different from Example-1 in that medium identification is performed prior to distinguishing the unrecorded area (in step A100 of FIG. 12). FIG. 20 shows the procedure of calibrating the recording condition in Example-3. The optical information recording/reproducing unit 10 (FIG. 11) identifies the optical disc 50, upon loading of the optical disc 50 thereto (step A10). The subsequent procedure is similar to the procedure shown in FIG. 12.

In step A10, identification of the optical disc 50 set is performed with respect to what kind of format the disc uses, which manufacturer the disc belongs to and so on. In addition, if it is judged that the disc is a recordable one, judgment is performed as to whether the disc is a low-to-high disc (LH medium) wherein reflectance of the mark is raised by recording of the mark, or a high-to-low disc (HL medium) wherein the reflectance is lowered by recording of the mark. In addition thereto, information of the number of recording films etc. is read from the optical disc 50, and then information of the power is read, and such information is set in the system controller 18.

Using the optical information recording/reproducing unit 10 having a configuration similar to that of Example-1 and along the procedure shown in FIG. 20, calibration of the recording condition was performed. Upon loading the optical disc 50 onto the optical information recording/reproducing unit 10, the medium identification in step A10 revealed that the optical disc 50 was a LH medium manufactured by the disc manufacturer A-2 and including a single recording film. Subsequently, the optical head 11 was moved to the drive test zone, to detect an area without a mark. Thereafter, recording was performed in step B120 (FIG. 13) under a plurality of recording conditions wherein the recording power is changed within a specific range from the center of the recording power stored in the device as the information thereof, with the bias power being fixed onto a bias power derived from the conversion information based on the recording power.

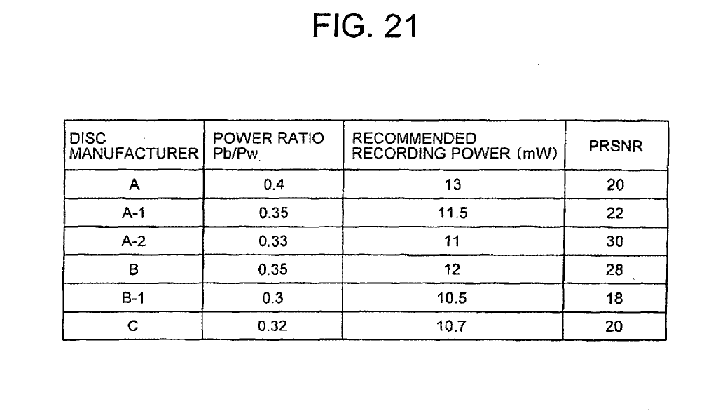

FIG. 21 shows a concrete example of the information for each disc manufacturer stored in the device. With reference to the information shown in the same drawing, the optical information recording/reproducing unit 10 obtains a recording power of Pw=11 that is recommended for the optical disc of the disk manufacturer A-2, and obtains a ratio of “0.33” for the bias power to the recording power. In step B120, recording was performed under a plurality of recording conditions wherein the recording power Pw is changed within a specific range from the center of the recommended recording power (11 mW), with the bias power Pb being fixed onto 0.33×recommended recording power (11 mW)=3.6 mW.

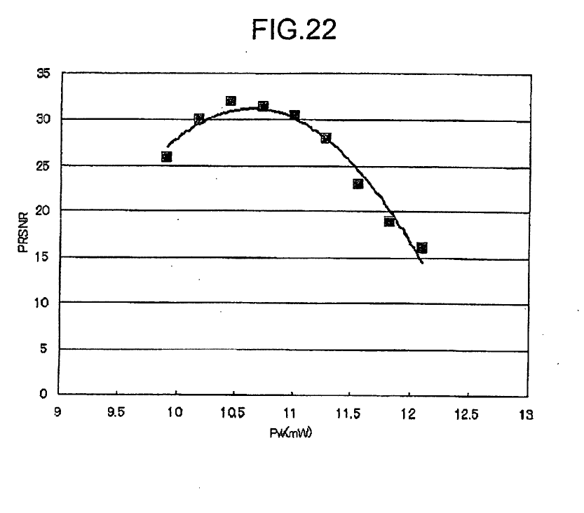

In step B140, the reproduced-signal quality was measured, to reveal the results shown in FIG. 22. The PRSNR assumed a maximum in the vicinity of a recording power of Pw=10.5 mW, whereby the optimum recording power was determined at 10.5 mW. In the step C100 (FIG. 12) of determining the bias power, the optimum bias power, 10.5 mW×0.33=3.5 mW, determined based on the ratio “0.33” (FIG. 21) of tile bias power to the recording power corresponding to the disc manufacturer A-2 was determined as the optimum bias power. Recording was performed using the combination of the optimum recording power and optimum bias power onto the entire surface of the optical disc, and it was assured here that a suitable reproduction is possible with the average number of errors being equal to or less than 20, as the number of correctable errors, in each 16 ECC blocks as a unit.

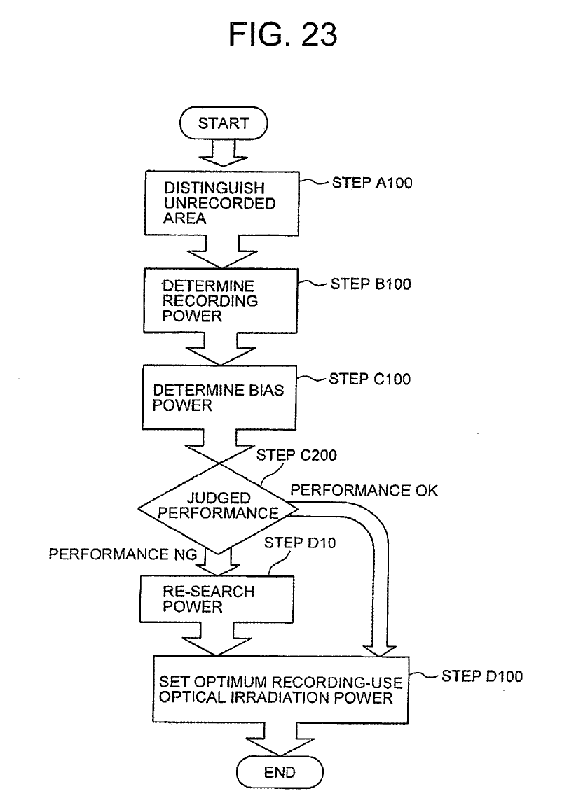

Example-4 will be described. The basic configuration of Example-4 is similar to that of Example-1, and is different therefrom in that performance judgment is performed succeeding to the determination of bias power (step C100 in FIG. 12). FIG. 23 shows the calibration procedure for the recording condition in Example-4. The processing of steps A100-C100 is similar to that of the procedure shown in FIG. 12. The optical information recording/reproducing unit 10, after determining the recording power and bias power, performs recording under the recording condition using this combination, to judge whether or not the reproduction performance is less than the medium performance grasped in advance (step C200).

Basically, the medium approved by a corresponding standard has a limited performance within a specific standard, and satisfies the fixed standard without fail. In step C200, it is judged whether or not the reproducing performance has a level without a problem for the device operation after the recording is performed using the combination of the recording power determined in step B100 and the bias power determined in step C100. If the reproducing performance is judged satisfactory for the device operation (Good in performance), the process advances to step D100 wherein the combination of the recording power and bias power is set as the recording condition. if the reproducing performance is judged unsatisfactory for device operation (NG in performance), re-search processing of the power is performed (step D10).

In the re-search processing of the power in step D10, the absolute value of the power is changed, for example, with the ratio of the recording power to the bias power being maintained constant. In an alternative, parameters relating to the recording, such as the tilt between the optical head and the medium or a focusing position, are adjusted to perform the recording using the power optimized at this stage, i.e., not the initially used recording power or bias power, while changing the recording power with the bias power being fixed constant. The recorded area is then reproduced for the performance judgment to again re-determine the optimum recording power. If the reproducing performance satisfies the specific performance at this stage, the process advances to step D100 wherein the combination of the optimum recording power and the fixed bias power is set as the condition. If the specific performance is not satisfied, recording is performed while changing the bias power with the optimum recording power thus re-determined being fixed, and the recorded area is then reproduced to determine the optimum bias power.

Calibration of the recording condition was performed using the procedure shown in FIG. 23 by using the optical information recording/reproducing unit 10 having a configuration similar to that of Example-1. After the optical disc 50 was set onto the optical information recording/reproducing unit 10, the optical disc 50 thus set was judged as one manufactured by the disc manufacturer B-1. The optical head 11 was first moved to the drive test zone of the optical disc 50, to detect the area without a mark. Subsequently, recording was performed under a plurality of recording conditions wherein the recording power was changed within a specific range from the center of the recording power stored in the device, with the bias power being fixed onto a bias power obtained from the recording power based on the conversion information. The recorded area was then reproduced, and the reproducing performance was measured to thereby determine the recording power. The bias power was determined thereafter.

The reproduced-signal quality was measured after the recording using the combination of the determined recording power and bias power, to reveal a PRSNR of about 15. With reference to the data of the disc manufacturer B-1 shown in FIG. 21 and stored in the device in advance, the PRSNR is 18, whereby it was judged by the performance judgment in step C200 (FIG. 23) that the performance was NG. In the re-search of the power in step D10, recording/reproduction was performed by changing the absolute value of power, with the ratio of the recording power determined in step B100 to the bias power determined in step C100 being fixed, to measure the PRSNR.

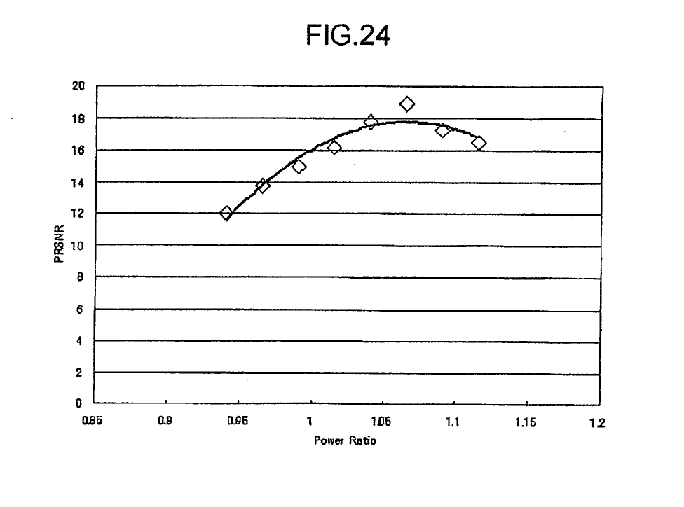

FIG. 24 shows measurement results of the reproduced-signal quality. With reference to FIG. 24, the PRSNR assumes a maximum at the power increased by 1.07 times. The PRSNR at this stage is about 19, which exceeds the performance (PRSNR=18) assumed in advance. Thus, re-search of the power was ended, and the powers obtained by multiplying the recording power determined in step B 100 and the bias power determined in step C100 by 1.07 times were set for the recording condition. By using the recording condition determined in this way, the performance of the medium could be derived to the maximum extent, whereby validity of the present embodiment could be assured.

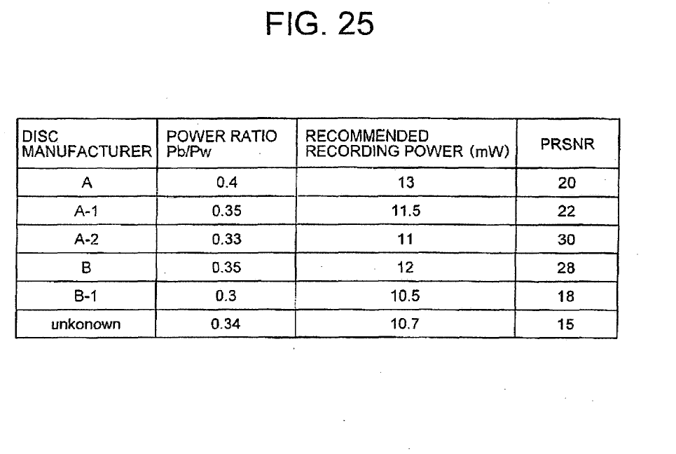

Example-5 will be described. The basic configuration of Example-5 is similar to that of Example-4, and is different therefrom in that medium identification is performed herein preceding to step A100 (FIG. 23). The medium identification was performed using a technique similarly to that of Example-3. After an optical disc 50 was set onto the optical information recording/reproducing unit 10, it was judged that disc was a LH medium and a write-once disc including a single recording film although identification of the manufacturer of the disc was impossible. FIG. 25 shows a concrete example of the information stored in the device for each disc manufacturer. With reference to FIG. 25, the manufacturer-unknown disc has a recommended recording power of 11.5 mW and 0.34 as the ratio of the bias power to the recording power. In step B120 (FIG. 13), recording was performed under a plurality of recording conditions wherein the recording power Pw was changed within a specific range from the center of the recommended recording power (11.5 mW), with the bias power Pb being fixed to the recommended recording power (11.5 mW)×0.34=3.9 mW.

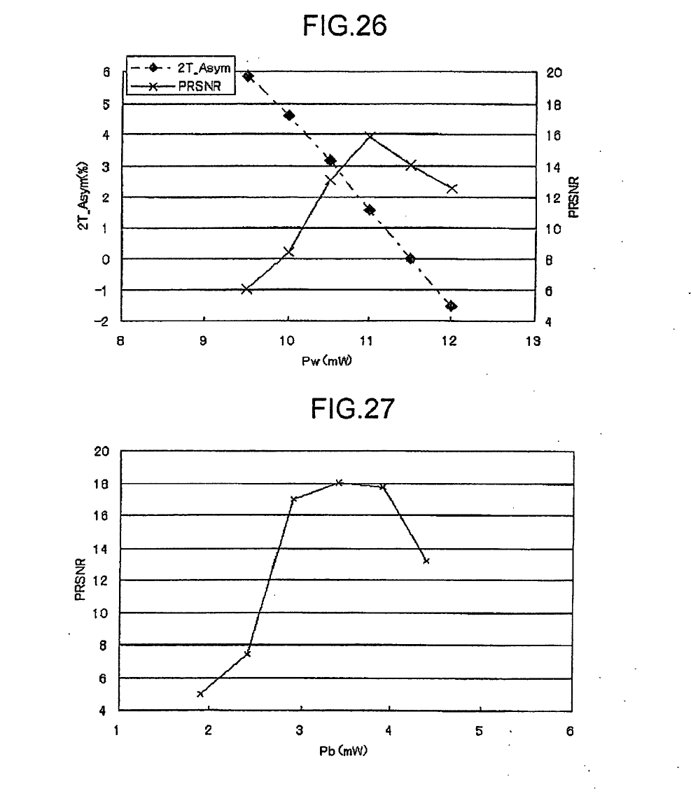

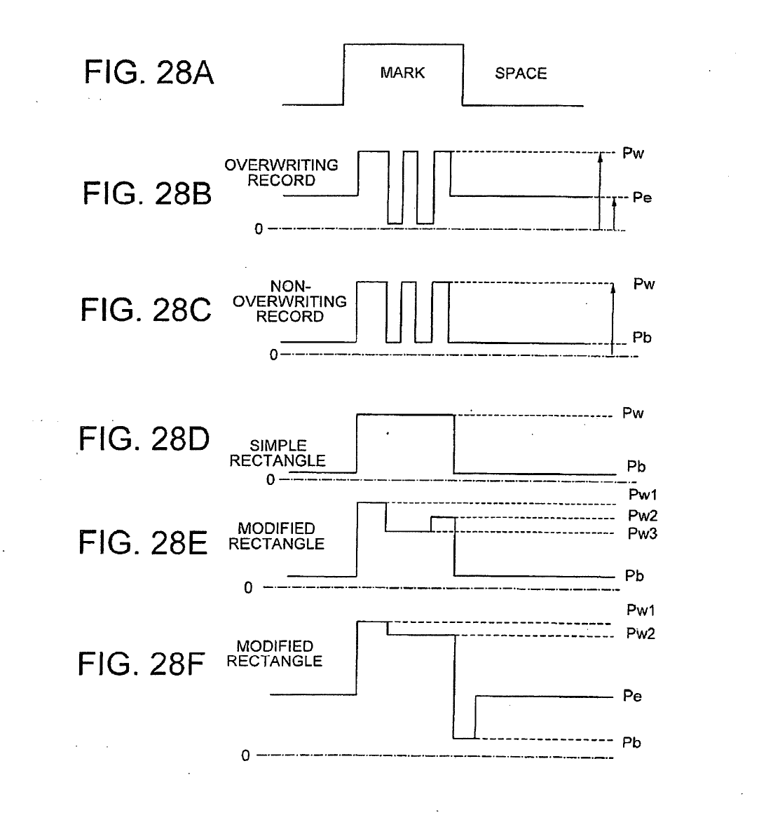

FIG. 26 shows the relationship between the recording power and the PRSNR. This figure additionally shows the relationship between the recording power and the asymmetry in 2T as a reference. The area recorded under the plurality of recording conditions was reproduced to measure the PRSNR, revealing the results shown in the FIG. 26. From the measurement results of the PRSNR shown in FIG. 26, a recording power of Pw=11 mW was determined as the optimum recording power. Thereafter, recording was performed under a plurality of recording conditions wherein the bias power was changed, with the recording power Pw being fixed to the optimum recording power (11 mW), and the recorded area was reproduced to measure the PRSNR. FIG. 27 shows the measurement results. From these results, a bias power of Pb=3.4 mW was determined as the optimum bias power.

Recording was performed using the combination of the above optimum recording power and optimum bias power, and the reproduced-signal quality was measured, revealing a PRSNR of around 18. With reference to FIG. 25, the unknown disc assumes a PRSNR of 15, whereby the performance is judged satisfactory by the performance judgment in step C200. Thus, a recording power of Pw=11 mW and a bias power of Pb=3.4 mW were determined as the recording-use powers.

Measurement of the 2T-asymmetry β-value under the above recording condition revealed a β-value of 0%, and this value was recorded in the drive test zone of the medium as the calibration information, obtained by the device as a device calibration, together with the device identification code (ID). The asymmetry value in tie recording power (11 mW) wherein the PRSNR assumes the maximum value before calibration was 1.5% (FIG. 26), which is different from the finally calibrated value (0%). It is preferable that the finally calibrated power provide an asymmetry of 0%, and in the present invention it was assured that a high-performance calibration that derives the maximum performance of the medium can be achieved. Thus, validity of the present invention can be confirmed.

In the above exemplary embodiment, an optical information recording/reproducing unit having a wavelength of 405 nm and a NA of 0.6 was used. However, the present invention is not limited to these configurations, and may be applied to a device having another wavelength and another NA. The recording waveform may be a recording waveform having a base on the pulse-train recording waveform or a recording waveform having a base on the rectangular waveform, and achieves similar advantage. Bias power 2 included in the recording power corresponding to the mark section in the case of using the pulse train waveform is not included in the calibration procedure in the embodiment because it does not relate directly to the present invention. However, in the case of a poor performance, this bias power 2 is also preferably subjected to the calibration. In this case, calibration of bias power 2 is preferably performed after the calibration of the bias power. Calibration for the recording waveform in the time axis direction, as the calibration for other than the power, may be performed as desired. As to the performance index used for determining the power other than those as described above, performance indexes known heretofore may be used depending on the device configuration. This may use the number of error bytes occurring in a specific number of ECC blocks, for example, or a number of PI errors that is the total number of lines for which an error is detected by the inner side parity of the ECC. That is, an index that can be basically replaced by an error index or an index that is used in a sense qualitatively equal to the error rate may be also used.

As described heretofore, in the calibration method for the recording-use optical irradiation power and optical information recording/reproducing unit according to the exemplary embodiment of the present invention, with respect to the write-once recoding medium for which recoding is performed by switching the irradiation between the recording power and the bias power depending on the mark and space, the recording power is first calibrated at a recording power that provides a suitable reproduced-signal quality, and thereafter, the bias power is determined using the calibrated recording power. More specifically, calibration of the recording power that determines the mark length (size) is first performed, followed by determining the mark-shaping power (bias power) matched with the calibrated recording power, i.e., matched with the mark formed thereby, whereby the recording-use optical irradiation power that provides a suitable recording/reproducing characteristic can be calibrated at a higher speed and with a higher degree of certainty.

Hereinafter, embodiments that may be employed in the present invention will be exemplified.

The recording-use optical-irradiation-power calibration method may employ a configuration wherein the bias power selecting step:

records a specific pattern train while stepwise changing the bias power with the recording power being fixed onto the selected recording power; measures a reproduced-signal quality by reproducing the recorded specific pattern train; and selects a bias power that provides a highest reproduced-signal quality from among bias powers that are stepwise changed therebetween. In the optical information recording/reproducing unit, a configuration may be employed wherein the parameter calibration unit selects, upon selecting the bias power, the bias power that allows the measured reproduced-signal quality to assume an optimum reproduced-signal quality from among bias powers that are stepwise changed therebetween, based on a reproduced-signal quality that is measured by the reproduced-signal quality measurement section from a pattern train that is recorded while changing the bias power with the recording power being fixed onto the selected recording power. In this case, a bias power that provides the best reproduced-signal quality in the combination with the selected recording power is selected as the bias power used during the recording, whereby it is possible to determine a recording-use optical irradiation power that can derive the medium performance at a maximum.

In an alternative of the above, the recording-use optical-irradiation-power calibration method of the present invention may employ a configuration wherein the bias power selecting step selects the bias power based on the selected recording power in accordance with a correspondence relationship specified in advance between the recording power and the bias power. In the optical information recording/reproducing unit, a configuration may be employed wherein the parameter calibration unit selects the bias power based on the selected recording power and a bias power that is set in connection with the recording power in advance. For example, the bias power is determined from the selected recording power based on the ratio of the recording power to the bias power. In the case of using this way, the time length of selection of the bias power can be reduced compared to the case of performing actual recording.

The recording-use optical-irradiation-power calibration method of the present invention may employ a configuration wherein the reproduced-signal quality includes at least one of a PRSNR and an error rate that is calculated based on a reproduced signal reproduced from the pattern train. In the optical information recording/reproducing unit of the present invention a configuration may be employed wherein the reproduced-signal quality measurement section calculates at least one of PRSNR and an error rate based on the reproduced signal.

The recording-use optical-irradiation-power calibration method of the present invention may further include the step of reading out control information including information of a setting of the bias power recorded on the recording medium, prior to the recording step, wherein: the recording step determines the specific bias power based on the information of setting of bias power included in the read-out control information. In the optical information recording/reproducing unit of the present invention, a configuration may be employed wherein the recording medium (50) records thereon control information including information of the bias power, and the parameter calibration unit determines the specific bias power, used upon performing recording while changing the recording power, based on information of setting of the bias power included in the control information. For example, if the control information includes a recommended value for the bias power suited for the set optical information recording medium, this information is used upon determining the bias power. In this case, the degree of the bias power determined in advance can be forecast.

In the recording-use optical-irradiation-power calibration method of the present invention, a configuration may be employed wherein the control information includes a correspondence relationship between the recording power and the bias power, and the bias power selecting step selects the bias power from the selected recording power based on information of the correspondence relationship. In the optical information recording/reproducing unit of the present invention, a configuration may be employed wherein the control information includes information of a correspondence relationship between the recording power and the bias power, and the parameter calibration unit selects the bias power based on the selected recording power in accordance with information of the correspondence relationship.

The recording-use optical-irradiation-power calibration method of the present invention may employ a configuration wherein the recording medium is a write-once medium, wherein a recorded mark is formed by a photochemical reaction or a photo-thermal-chemical reaction, at least a portion of a recording film in the recording medium is formed from an organic pigment, and the medium is configured such that an optical reflectance of a mark section formed by the optical beam irradiation is higher than an optical reflectance prior to the laser beam irradiation. In the optical information recording/reproducing unit of the present invention, a configuration may be employed wherein the recording medium is a write-once recording medium for which a recorded mark is mainly formed by photochemical reaction or a photo-thermal-chemical reaction, at least a part of a recording film of the recording medium is formed from an organic pigment, and an optical reflectance of a mark section formed by the optical beam irradiation is higher than an optical reflectance of the medium prior to the laser beam irradiation.

While the present invention has been described based on the preferred embodiment thereof, the calibration method for the optical irradiation power and the optical information recording/reproducing unit of the present invention are not limited only to the configuration of the above exemplary embodiment, and a variety of modifications and alterations of the configuration of the above embodiment may fall within the scope of the present invention.

### INDUSTRIAL APPLICABILITY

The present invention can be widely applied, as the optical-irradiation-power calibration method, to the recording by switching the irradiation onto a write-once recording medium (medium for which a recorded mark is formed by a photochemical reaction or photo-thermal-chemical reaction) between the recording power and the bias power (mark-shaping power) depending on the mark and space, and can achieve the advantage that the calibration time length for the recording-use optical irradiation power, calibration accuracy thereof, and reliability of the device using the same can be drastically improved.

This application is based upon and claims the benefit of priority from Japanese patent application No. 2006-250870, filed on Sep. 15, 2006, the disclosure of which is incorporated herein in its entirety by reference.

1-14. (canceled)

15. A method for calibrating an optical irradiation power in an optical information recording/reproducing unit that performs recording on a write-once recording medium, wherein a mark is formed by optical beam irradiation and a beam having at least three power levels including a recording power corresponding to a mark and a bias power corresponding to a space is irradiated upon the recording, comprising:
recording a specific pattern train in a specific area on the recording medium while stepwise-changing the recording power among a plurality of first recording powers, with the bias power being fixed at a fixed bias power;
reproducing said pattern train recorded in said recording step to measure a reproduced-signal quality;
selecting one of said first recording powers based on said measured reproduced-signal quality;
selecting a specific bias power by using said selected one of said first recording powers; and
forming a mark by irradiating said selected one of said first recording powers and said specific bias power.

16. The method according to claim 15, wherein:
said specific bias power selecting comprises:
recording a specific pattern train while stepwise-changing the recording power among a plurality of first bias powers, with the recording power being fixed at said selected one of said first recording powers;
measuring a reproduced-signal quality by reproducing said recorded specific pattern train; and
selecting, as said specific bias power, one of said first bias powers that provides a highest reproduced-signal quality among said first bias powers.

17. The method according to claim 15, wherein said specific bias power selecting selects said one of said first bias powers based on said selected one of said recording powers in accordance with a correspondence relationship specified in advance between the recording power and the bias power.

18. The method according to claim 15, wherein said reproduced-signal quality includes at least one of a PRSNR and an error rate that is calculated based on a reproduced signal reproduced from said pattern train.

19. The method according to claim 15, further comprising reading out control information including information of a setting of the bias power recorded on said recording medium, prior to said recording step, wherein:
said recording determines said fixed bias power based on said information of setting of the bias power included in said read-out control information.

20. The method according to claim 19, wherein said control information includes a correspondence relationship between the recording power and the bias power, and said specific bias power selecting selects said specific bias power from said selected recording power based on information of said correspondence relationship.

21. The method according to claim 15, wherein said write-once recording medium is such that a recorded mark is formed by a photochemical reaction or a photo-thermal-chemical reaction, at least a portion of a recording film in said recording medium is formed from an organic pigment, and an optical reflectance of a mark section formed by said optical beam irradiation is higher than an optical reflectance prior to said laser beam irradiation.

22. An information recording/reproducing unit that records/reproduces data on a write-once recording medium, wherein a mark is formed by optical beam irradiation and a beam having at least three power levels including a recording power corresponding to a mark and a bias power corresponding to a space is irradiated upon the recording, said information recording/reproducing unit comprising:
a parameter calibration unit that determines a recording power and a bias power of a laser beam that irradiates the recording medium upon performing recording on the recording medium, wherein:
said parameter calibration unit comprises a reproduced-signal quality measurement section that measures a reproduced-signal quality of a specific pattern train, which is recorded in a specific recording area while stepwise-changing the recording power among a plurality of first recording powers with the bias power being fixed at a fixed bias power;
said parameter calibration unit selects one of said first recording powers based on said reproduced-signal quality, selects a specific bias power based on said selected one of said first recording powers, and determines said selected one of said first recording powers and said selected specific bias power as a recording power and a bias power, respectively, upon recording a mark.

23. The optical information recording/reproducing unit according to claim 22, wherein said parameter calibration unit selects, upon selecting said specific bias power, one of a plurality of first bias powers that allows said measured reproduced-signal quality to assume a highest reproduced-signal quality, based on a reproduced-signal quality that is measured by said reproduced-signal quality measurement section from a pattern train that is recorded while changing the bias power among said first bias powers with the recording power being fixed at said selected one of said recording powers.

24. The optical information recording/reproducing unit according to claim 22, wherein said parameter calibration unit selects said specific bias power based on said selected one of said first recording powers in accordance with a correspondence relationship determined in advance between the recoding power and the bias power.

25. The optical information recording/reproducing unit according to claim 22, wherein said reproduced-signal quality measurement section calculates at least one of PRSNR and an error rate based on the reproduced signal.

26. The optical information recording/reproducing unit according to claim 22, wherein the recording medium records thereon control information including information of the bias power, and said parameter calibration unit determines said fixed bias power based on information of setting of the bias power included in the control information.

27. The optical information recording/reproducing unit according to claim 26, wherein said control information includes information of a correspondence relationship between the recording power and the bias power, and said parameter calibration unit selects said specific bias power based on said selected one of said first recording powers in accordance with information of said correspondence relationship.

28. The optical information recording/reproducing unit according to claim 22, wherein the write-once recording medium is such that a recorded mark is mainly formed by photochemical reaction or a photo-thermal-chemical reaction, at least a part of a recording film of the recording medium is formed from an organic pigment, and an optical reflectance of a mark section formed by said optical beam irradiation is higher than an optical reflectance of the recording medium prior to said laser beam irradiation.
